(19) United States
(12) Patent Application Publication
(10) Pub. No.: US 2018/0305603 A1
(43) Pub. Date: Oct. 25, 2018

(54) HYDROPHOBIZING TREATMENTS AND AGENTS AND METHODS OF USE IN SUBTERRANEAN FORMATIONS

(71) Applicant: Halliburton Energy Services, Inc., Houston, TX (US)

(72) Inventors: William Walter Shumway, Spring, TX (US); Cato Russell McDaniel, Montgomery, TX (US); Alfredo Villarreal, Houston, TX (US); Catherine Martin Santos, Houston, TX (US)

(21) Appl. No.: 15/771,919

(22) PCT Filed: Dec. 30, 2015
(86) PCT No.: PCT/US2015/068097

§ 371 Date: Apr. 27, 2018

(51) Int. Cl. C09K 8/54; C09K 8/52; E21B 21/00; E21B 43/26; E21B 37/00

(52) U.S. Cl. CPC C09K 8/54; C09K 8/52; C09K 2208/26; E21B 43/26; E21B 37/00; E21B 21/003

(57) ABSTRACT

Systems and methods for using hydrophobizing agents to prevent or delay acidization and/or improve filter cake removal in subterranean formations are provided. In certain embodiments, the methods comprise: providing a treatment fluid comprising an aqueous base fluid and one or more hydrophobizing agents; contacting at least a portion of a surface within a subterranean formation with the treatment fluid; and allowing the hydrophobizing agent to interact with the portion of the surface within the subterranean formation to reduce its reactivity with an acid.

### BACKGROUND

The present disclosure relates to systems and methods for treating subterranean formations.

Treatment fluids can be used in a variety of subterranean treatment operations. As used herein, the terms “treat,” “treatment,” “treating,” and grammatical equivalents thereof refer to any subterranean operation that uses a fluid in conjunction with achieving a desired function and/or for a desired purpose. Use of these terms does not imply any particular action by the treatment fluid. Illustrative treatment operations can include, for example, fracturing operations, gravel packing operations, drilling operations, acidizing operations, scale dissolution and removal, consolidation operations, and the like.

Acidic fluids and/or gases are often encountered in subterranean formations and may cause undesired corrosion, degradation, and/or other damage in the formation. For example, certain acid gases such as CO₂ or H₂S may be naturally-occurring in certain formations. Moreover, certain subterranean treatment operations involve introducing acidic fluids or additives into the formation to perform one or more functions. For example, when a drilling fluid or other treatment fluid is used in a subterranean formation, it often leaves behind solid deposits (e.g., comprising particulate bridging agents) in the form of a filter cake on surfaces in the formation, such as the inner surface of a well bore penetrating the formation, which may hinder subsequent production of fluids from the formation. In some instances, acid breaker systems are used to degrade such filter cakes and/or other damaged areas within the formation. However, it is typically desirable to remove the drilling fluid and/or drilling equipment from the well bore before degradation of the filter cake begins, which may take a significant amount of time, particularly in long, horizontal well bores where equipment must be tripped out of the well. Moreover, where the filter cake must be removed along the entire length of a long well bore, the acid may spend in the regions of a well bore near the injection point before it can reach and effectively treat the filter cake in other regions of the well bore. Premature and/or uneven degradation of the filter cake may cause, among other problems, significant leak-off of treatment fluids (e.g., drilling fluids) into the formation, which may cause further damage or delay production of other fluids from the well. For these reasons, acid breakers are often formulated in an attempt to delay the release of the acid to prevent premature breaking of the filter cake before equipment and fluids are removed.

In another example, acidic fluids are sometimes used in stimulation operations called acidizing operations. Where the subterranean formation comprises acid-soluble components, such as those present in carbonate and sandstone formations, stimulation is often achieved by contacting the formation with a treatment fluid that comprises an acid. For example, where hydrochloric acid contacts and reacts with calcium carbonate in a formation, the calcium carbonate is consumed to produce water, carbon dioxide, and calcium chloride. After acidization is completed, the water and salts dissolved therein may be recovered by producing them to the surface (e.g., “flowing back” the well), leaving a desirable amount of voids (e.g., wormholes) within the formation, which may enhance the formation's permeability and/or increase the rate at which hydrocarbons subsequently may be produced from the formation. One method of acidizing known as “fracture acidizing” comprises injecting a treatment fluid that comprises an acid into the formation at a pressure sufficient to create or enhance one or more fractures within the subterranean formation. Another method of acidizing known as “matrix acidizing” comprises injecting a treatment fluid that comprises an acid into the formation at a pressure below that which would create or enhance one or more fractures within the subterranean formation. However, if the acidic fluids used in these acidizing treatments are not adequately controlled, they may penetrate a region of the formation where stimulation is not desired (e.g., a water producing region). Unintended or accidental acidization of these regions may negatively impact or delay the production of hydrocarbons from the well bore.

### BRIEF DESCRIPTION OF THE DRAWINGS

These drawings illustrate certain aspects of some of the embodiments of the present disclosure, and should not be used to limit or define the claims.

FIG. 1 is a diagram illustrating a well bore penetrating a subterranean formation that is treated according to certain embodiments of the present disclosure.

FIG. 2 is a diagram illustrating the well bore penetrating the subterranean formation of FIG. 1 at a subsequent point in time during a treatment according to certain embodiments of the present disclosure.

FIG. 3 is a diagram illustrating the well bore penetrating the subterranean formation of FIG. 1 following a treatment according to certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

The present disclosure relates to systems and methods for treating subterranean formations. More particularly, the present disclosure relates to systems and methods for using hydrophobizing agents to prevent or delay acidization and/or improve filter cake removal in subterranean formations.

The present disclosure provides methods and systems for treating subterranean formations using one or more hydrophobizing agents. In certain embodiments, the methods of the present disclosure comprise providing a treatment fluid comprising an aqueous base fluid and one or more hydrophobizing agents, and contacting at least a portion of a surface or filter cake within the subterranean formation with the treatment fluid (e.g., by introducing the treatment fluid into at least a portion of a subterranean formation via a well bore penetrating the portion of the subterranean formation). In certain embodiments, the methods of the present disclosure comprise using particulate bridging agents that have previously been treated (e.g., coated) with one or more hydrophobizing agents to form at least a portion of a filter cake in a subterranean formation. Without limiting the disclosure to any particular theory or mechanism, it is believed that such hydrophobizing agents may react with compounds present on the surface, filter cake, and/or particulate bridging agent to form an inert substance that is less water soluble or less reactive with an acid than the surface itself. In other embodiments, the hydrophobizing agents be deposited and/or form a partial coating on the surface, filter cake, and/or particulate bridging agent.

The treatments and methods using hydrophobizing agents according to the present disclosure may serve a number of different functions in a subterranean formation. In certain embodiments, the presence of the hydrophobizing agent on a surface, filter cake, or particulate in the subterranean formation may protect the formation and/or reduce its susceptibility to acidization by increasing its resistance to water invasion and/or reducing its reactivity with an acid. This type of treatment may be used, among other purposes, to protect acid-sensitive formations, to protect selected portions of a formation while acidizing others, to delay the action of acid-releasing additives used to acidize a filter cake or other unwanted substances in a formation, and the like. In certain embodiments, this may allow an acidizing fluid and/or additive to penetrate further into a subterranean formation and/or reach downhole regions of a well bore before the acid is spent. In other embodiments, the hydrophobizing agent may be introduced into a formation so as to contact a porous surface in a formation. The deposition of the hydrophobizing agent on the surface of such a porous formation may prevent acids from “spending” on the formation surface but allow them to penetrate deeper into the formation matrix, which may enhance the effectiveness of an acidizing and/or cleanup operation.

The treatment fluids used in the methods and systems of the present disclosure may comprise any aqueous base fluid known in the art. The term “base fluid” refers to the major component of the fluid (as opposed to components dissolved and/or suspended therein), and does not indicate any particular condition or property of that fluids such as its mass, amount, pH, etc. Aqueous fluids that may be suitable for use in the methods and systems of the present disclosure may comprise water from any source. Such aqueous fluids may comprise fresh water, salt water (e.g., water containing one or more salts dissolved therein), brine (e.g., saturated salt water), seawater, or any combination thereof. In most embodiments of the present disclosure, the aqueous fluids comprise one or more ionic species, such as those formed by salts dissolved in water. For example, seawater and/or produced water may comprise a variety of monovalent and/or divalent cationic and anionic species dissolved therein. In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of viscosifying agents, acids, and other additives included in the fluid. One of ordinary skill in the art, with the benefit of this disclosure, will recognize when such density and/or pH adjustments are appropriate.

The hydrophobizing agents used in the methods and compositions of the present disclosure may comprise any compound capable of rendering a surface hydrophobic or less reactive with acids. In certain embodiments, the hydrophobizing agent may accomplish this by adsorbing onto, binding to, or reacting with the hydrophilic surface. Examples of compounds that may be suitable as hydrophobizing agents in certain embodiments of the present disclosure include, but are not limited to, polymers having one or more pendant acid moieties, long chain fatty acids (e.g., stearic acid, oleic acid, lauric acid, caproic acid, etc.), organic acids, organosilanes, silicone, silica, alumina, titania, zirconia, gold, thiols, nano-materials (e.g., nano-scale materials comprising silica, alumina, gold, silver, copper, or other transition metals), functionalized carbon-based nano-materials (e.g., graphene oxides, COOH-terminated carbon nanotubes and graphenes), carbohydrates, proteins, lipids, nucleic acids, and any combination thereof. The fatty acids and/or organic acids used in certain embodiments of the present disclosure may include carbon chains (e.g., alkyl groups, alkene groups, alkyne groups, or a combination thereof, each of which may be branched, unbranched, or cyclic) of any suitable length. In certain embodiments, the fatty acids and/or organic acids may include chains of 3 to 36 carbon atoms. In certain embodiments, the fatty acids and/or organic acids may include chains of 12 to 18 carbon atoms. In certain embodiments, the fatty acids and/or organic acids may include chains of 16 to 18 carbon atoms.

In certain embodiments, a hydrophobizing agent may be deposited on a surface of a particulate using any suitable means known in the art. In certain embodiments, certain of these materials may be deposited on a surface using a sol-gel process. In certain embodiments, such materials may be deposited onto a surface of the particulate to at least partially (or entirely) coat the surface of the particulate. In certain embodiments, certain of these materials may form a monolayer on the surface to which they are applied. For example, when used in a formation comprising calcium carbonate, a stearic acid hydrophobizing agent may contact the calcium carbonate surface and react with the calcium carbonate to form calcium stearate, which is not generally soluble in water or oil. The calcium stearate formed on the formation surface may, among other actions, prevent the penetration of water or acid into the underlying rock matrix.

The hydrophobizing agents may be included in a treatment fluid of the present disclosure in any concentration sufficient to adequately treat the surface within the formation. Thus, the concentration of the hydrophobizing agent may depend upon the amount of surface area to be treated, the desired delay time in delaying penetration of an acid or aqueous fluid, and other factors that a person of skill in the art with the benefit of this disclosure will recognize. In certain embodiments, the hydrophobizing agents may be included in a treatment fluid in a concentration of up to about 5% by weight of the fluid. In certain embodiments, the hydrophobizing agents may be included in a treatment fluid in a concentration of from about 0.01% to about 5% by weight of the fluid. In certain embodiments, the hydrophobizing agents may be included in a treatment fluid in a concentration of from about 0.5% to about 2% by weight of the fluid. In certain embodiments, the hydrophobizing agents may be included in a treatment fluid in a concentration of about 1% by weight of the fluid.

In certain embodiments, the treatment fluids used in the methods and systems of the present disclosure optionally may comprise any number of additional additives. Examples of such additional additives include, but are not limited to, salts, surfactants, acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, flocculants, additional H₂S scavengers, CO₂ scavengers, oxygen scavengers, lubricants, viscosifiers, breakers, weighting agents, relative permeability modifiers, resins, wetting agents, coating enhancement agents, filter cake removal agents, antifreeze agents (e.g., ethylene glycol), and the like. In certain embodiments, one or more of these additional additives (e.g., a crosslinking agent) may be added to the treatment fluid and/or activated after the viscosifying agent has been at least partially hydrated in the fluid. A person skilled in the art, with the benefit of this disclosure, will recognize the types of additives that may be included in the fluids of the present disclosure for a particular application.

The treatment fluids of the present disclosure may be prepared using any suitable method and/or equipment (e.g., blenders, mixers, stirrers, etc.) known in the art at any time prior to their use. The treatment fluids may be prepared at least in part at a well site or at an offsite location. In certain embodiments, the hydrophobizing agent(s) and/or other components of the treatment fluid may be metered directly into an aqueous base fluid to form a treatment fluid. In certain embodiments, the base fluid may be mixed with the hydrophobizing agent(s) and/or other components of the treatment fluid at a well site where the operation or treatment is conducted, either by batch mixing or continuous (“on-the-fly”) mixing. The term “on-the-fly” is used herein to include methods of combining two or more components wherein a flowing stream of one element is continuously introduced into a flowing stream of another component so that the streams are combined and mixed while continuing to flow as a single stream as part of the on-going treatment. Such mixing can also be described as “real-time” mixing. In other embodiments, the treatment fluids of the present disclosure may be prepared, either in whole or in part, at an offsite location and transported to the site where the treatment or operation is conducted. In introducing a treatment fluid of the present disclosure into a portion of a subterranean formation, the components of the treatment fluid may be mixed together at the surface and introduced into the formation together, or one or more components may be introduced into the formation at the surface separately from other components such that the components mix or intermingle in a portion of the formation to form a treatment fluid. In either such case, the treatment fluid is deemed to be introduced into at least a portion of the subterranean formation for purposes of the present disclosure.

In certain embodiments, the methods and compositions of the present disclosure may be used to delay, hinder, and/or prevent the penetration of acids and/or aqueous fluids into acid-sensitive or water-sensitive regions of or materials in a formation. These types of regions may include, but are not limited to limestone formations, carbonate formations, acid-sensitive cements, shale formations, water-swellable materials, and the like. These treatments may protect these types of formations from naturally-occurring water or acids as well as aqueous fluids and acids that are introduced into the formation in the course of one or more operations in the formation.

The present disclosure in some embodiments provides methods for using the treatment fluids in conjunction with a variety of subterranean treatments, including but not limited to, acidizing treatments, drilling operations, scale treatment operations, wellbore cleanout operations, completion operations, and the like. In some embodiments, the treatment fluids of the present disclosure may be used in conjunction with other treatments in a portion of a subterranean formation, for example, in acidizing treatments such as matrix acidizing or fracture acidizing. For example, where the subterranean formation comprises acid-soluble components, such as those present in carbonate and sandstone formations, the formation may be contacted with a treatment fluid that comprises an acid to dissolve at least a portion of the formation. The acids used in such fluids may comprise any acid known in the art, including organic acids, inorganic acids (e.g., hydrochloric acid) and any combination thereof. After acidization is completed, the water and salts dissolved therein may be recovered by producing them to the surface (e.g., “flowing back” the well), leaving a desirable amount of voids (e.g., wormholes) within the formation, which may enhance the formation's permeability and/or increase the rate at which hydrocarbons subsequently may be produced from the formation.

In certain embodiments, the treatment fluids of the present disclosure may be applied to a particular portion of a subterranean formation to reduce its reactivity with acid or susceptibility to water invasion prior to an operation in which an acidic treatment fluid or additive will be introduced into the formation. This may be done to protect certain regions of a formation from being acidized and/or to selectively or more effectively acidize other regions of the formation. In certain embodiments, a treatment fluid comprising one or more hydrophobizing agents initially may be introduced into a more permeable region of a formation or a region where stimulation is not desired (e.g., a carbonate formation), followed by an acidic treatment fluid. Because the more permeable region of the formation was first treated with the hydrophobizing agents, the acidic treatment fluid may be diverted from or may pass through that region unspent and without significantly dissolving that portion of the formation, allowing the acidic treatment fluid to flow into and treat (i.e., acidize) a different, less permeable region of the formation. In this way, a treatment fluid of the present disclosure may act as a diverting agent or isolation tool for selectively treating certain regions of the formation.

In certain embodiments, the methods and compositions of the present disclosure also may be used to enhance matrix acidization treatments by allowing the acid to penetrate more deeply into acid-sensitive formations such as carbonate formations. For example, a hydrophobizing agent of the present disclosure may be introduced into a formation so as to contact a surface in a formation to be acidized. In these embodiments, a relatively smaller amount or concentration of the hydrophobizing agent may be used so as to treat only the surface of the formation without allowing the hydrophobizing agent to penetrate into the rock matrix. The deposition of the hydrophobizing agent on only the surface of such a formation may prevent acids from “spending” on the formation surface and allow the acid to penetrate deeper into the formation matrix, which may enhance the effectiveness of an acidizing and/or cleanup operation.

In certain embodiments, the methods and compositions of the present disclosure may be used to form and/or treat filter cakes in subterranean well bores (particularly long, horizontal well bores) to allow for more effective and/or uniform removal of the filter cakes, e.g., along the entire well bore. In certain embodiments, an acid and/or an acid generating component may be introduced into the formation, among other purposes, to degrade a filter cake and/or other undesired substances in the formation. In certain embodiments, the hydrophobizing agents of the present disclosure may serve to delay (or further delay) the reaction of the acid with the filter cake or other undesired substances. In some embodiments, an existing filter cake (e.g., a filter cake comprising particulate bridging agents) may be contacted with a hydrophobizing agent of the present disclosure to render it more hydrophobic and/or to decrease its reactivity with acids. In other embodiments, a particulate bridging agent to be included in a treatment fluid (e.g., a drilling fluid) may be contacted with a hydrophobizing agent of the present disclosure such that the hydrophobizing agent is deposited (e.g., coated) on its surface, renders the surface of the particulate at least partially hydrophobic, and/or decreases the particulate's reactivity with acids before it is introduced into a well bore. When the particulate bridging agent is introduced into the well bore, it may form a portion of a filter cake that may be at least partially hydrophobic and/or less reactive with acids.

The particulate bridging agents used and/or present in filter cakes in certain embodiments of the present disclosure may comprise any particulate material that is capable of bridging over the pores in the surfaces of the formation or well bore such that a filter cake is deposited thereon. In certain embodiments, the bridging agent may be substantially insoluble in, for example, the drilling fluid or other treatment fluid in which it is used. Examples of materials that may be suitable as particulate bridging agents in certain embodiments of the present disclosure include, but are not limited to, carbonate compounds (e.g., calcium carbonate), magnesium compounds (e.g., magnesium oxide), manganese oxide, zinc oxide, zinc carbonate, calcium sulfate, magnesium citrate, calcium citrate, calcium succinate, calcium maleate, calcium tartrate, magnesium tartrate, bismuth citrate, ceramic materials, resinous materials, polymeric materials, and any combination or mixture thereof. The particulate bridging agent may be present in the drilling or treatment fluid in an amount sufficient to create an efficient filter cake. As referred to herein, the term “efficient filter cake” will be understood to mean a filter cake comprising an amount of material required to provide a desired level of fluid loss control. In certain embodiments, the bridging agent may be present in the drilling or treatment fluid in an amount ranging from about 0.1% to about 40% by weight. In certain embodiments, the bridging agent may be present in the drilling or treatment fluid in an amount in the range of from about 3% and about 10% by weight. Generally, the particle size of the particulate bridging agent used is determined by the pore throat size of the formation in which it will be used. In certain embodiments, the particulate bridging agents may have a particle size in the range of from about 1 micron to about 600 microns. In certain embodiments, the particulate bridging particle size is in the range of from about 1 to about 200 microns.

The acid-generating components used in certain embodiments of the present disclosure may comprise any compound that at least partially hydrolyzes in water to release an acid. Examples of acid generating components that may be suitable for use in the present disclosure include, but are not limited to, esters, formates, lactic acid derivatives, methyl lactate, ethyl lactate, propyl lactate, and butyl lactate. Other suitable delayed acid generating component include: formate esters including, but are not limited to, ethylene glycol monoformate, ethylene glycol diformate, diethylene glycol diformate, glyceryl monoformate, glyceryl diformate, glyceryl triformate, triethylene glycol diformate and formate esters of pentaerythritol. Examples of esters also include esters or polyesters of glycerol including, but not limited to, tripropionin (a triester of propionic acid and glycerol), trilactin, and esters of acetic acid and glycerol such as monoacetin, diacetin, and triacetin. In certain embodiments, the acid generating component may include aliphatic polyesters; poly(lactides); poly(glycolides); poly(ε-caprolactones); poly(hydroxy ester ethers); poly(hydroxybutyrates); poly(anhydrides); aliphatic polycarbonates; poly(orthoesters); poly(amino acids); poly(ethylene oxides); and polyphosphazenes; or copolymers thereof. Derivatives and combinations of any of the aforementioned examples also may be suitable. For example, various combinations of the esters or polyesters of hydroxy acid and/or glycerol also may be employed to adjust the half-life of the hydrolysis reactions. In certain embodiments, the acid generating component can be encapsulated with an encapsulating material to form a solid capsule. In other embodiments, the delayed acid generating component may not be encapsulated. Examples of commercially-available acid-generating compounds that may be suitable for use in the methods and compositions of the present disclosure include, but are not limited to N-FLOW™ 325, N-FLOW™ 408, N-FLOW™ 412, and N-FLOW™ 457, all of which are available from Halliburton Energy Services, Inc.

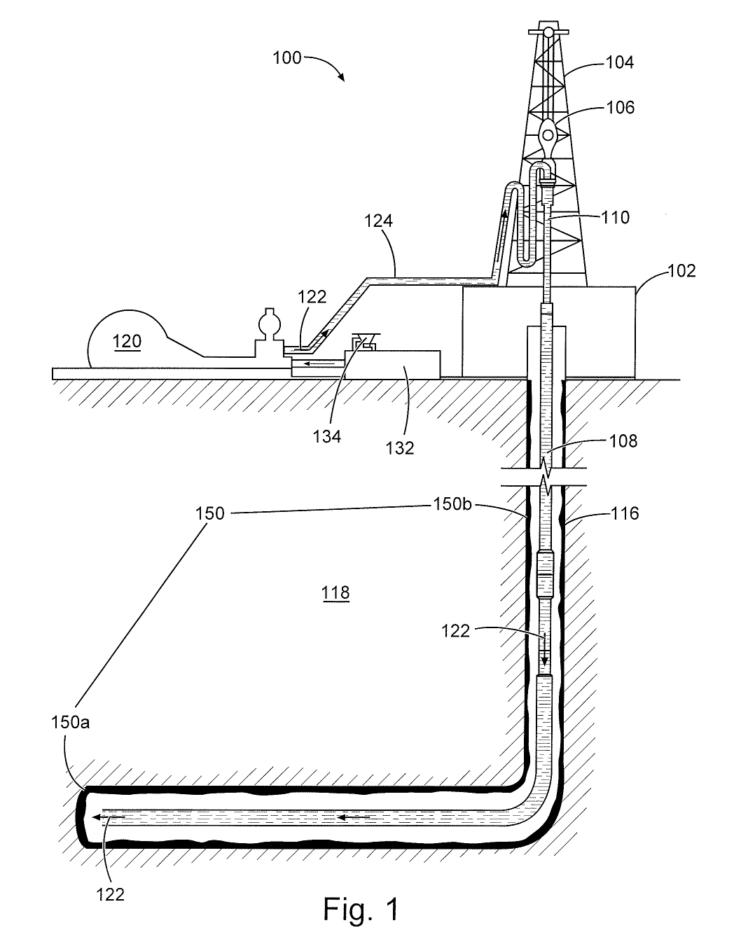

The methods and/or treatment fluid(s) of the present disclosure herein may directly or indirectly affect one or more components or pieces of equipment associated with the preparation, delivery, recapture, recycling, reuse, and/or disposal of the treatment fluids. For example, the treatment fluid(s) of the present disclosure may directly or indirectly affect one or more components or pieces of equipment associated with a wellbore treatment assembly, according to one or more embodiments. An example of a well site and treatment assembly where treatments according to certain embodiments of the present disclosure may be performed is shown in FIGS. 1-3. It should be noted that while FIGS. 1-3 generally depicts a land-based treatment assembly, those skilled in the art will readily recognize that the principles described herein are equally applicable to subsea treatment operations that employ floating or sea-based platforms and rigs, without departing from the scope of the disclosure.

Referring now to FIG. 1, the treatment assembly 100 may include a platform 102 that supports a derrick 104 having a traveling block 106 for raising and lowering a work string 108. The work string 108 may include, but is not limited to, pipe and coiled tubing, as generally known to those skilled in the art. A kelly 110 supports the work string 108 as it is lowered below the platform 102 and into a borehole 116 that penetrates various subterranean formations 118. Borehole 116 is depicted as having a vertical section and a downhole horizontal section, although a person of skill in the art with the benefit of this disclosure will recognize that the methods of the present disclosure may be applied to boreholes of any configuration and/or orientation. A filter cake 150 resides on in the inner walls of borehole 116 along substantially its entire length. In certain embodiments, filter cake 150 may have been deposited in borehole 116 in the course of a drilling operation, and it may be desirable to remove filter cake 150 to allow production of fluids from the formation 118 into the borehole 116. In embodiments of the present disclosure, the filter cake 150 may have been treated with one or more treatment fluids or hydrophobizing agents of the present disclosure, among other reasons, to inhibit its reactivity with acid and/or water. For example, a treatment fluid of the present disclosure comprising one or more hydrophobizing agents may have previously been pumped into borehole 116 to contact the filter cake 150. In other embodiments, the filter cake 150 may include particulates that were carried into borehole 116 in a drilling fluid or other treatment fluid but were previously coated or otherwise treated with one or more hydrophobizing agents according to the present disclosure.

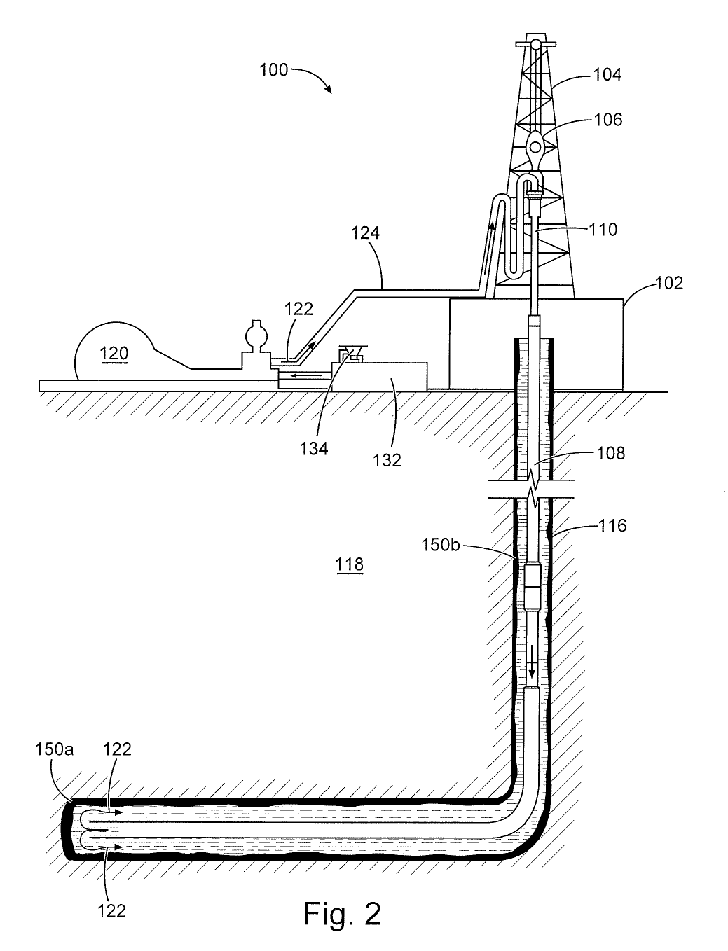

A breaker fluid comprising a filter cake breaker (such as an acid and/or acid releasing component) may be prepared in one or more blender unit(s) 132. Those skilled in the art will readily appreciate that the blender unit(s) 132 may be arranged at any other location in the treatment assembly 100 to facilitate its proper function, without departing from the scope of the scope of the disclosure. One or more additives (e.g., breakers, acids, etc.) may be added to the breaker fluid in the blender unit 132 via a hopper 134 communicably coupled to or otherwise in fluid communication therewith. The hopper 134 may include, but is not limited to, bins and metering equipment known to those skilled in the art. The blender unit(s) 132 may further include one or more sensors, gauges, pumps, compressors, and the like used store, monitor, regulate, and/or condition the treatment fluid(s). A pump 120 (e.g., a mud pump) circulates the prepared breaker fluid 122 through a feed pipe 124 and to the kelly 110, which conveys the treatment fluid 122 downhole through the interior of the work string 108 and through one or more orifices at a downhole end of the work string 108. The breaker fluid 122 then circulates into the annular region between the outer surface of work string 108 and the inner wall of borehole 116, and eventually fills the annular region throughout the well bore, as shown in FIG. 2. By contacting the filter cake 150, the acid in the breaker fluid 122 may degrade it, facilitating its circulation out of the well bore.

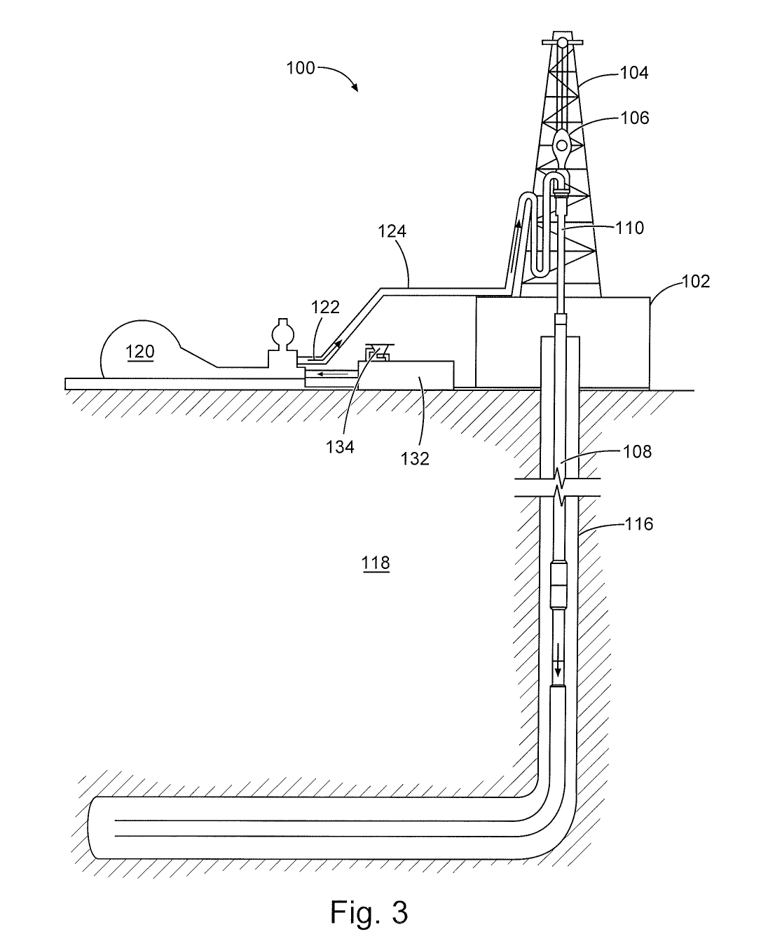

In conventional treatments, the breaker fluid 122 might quickly react with a portion 150a of the filter cake proximate to where the breaker fluid 122 exits the work string 108 such that significantly less unspent acid remains in breaker fluid 122 by the time it reaches other portions 150b of the filter cake further uphole. This may result in the removal of less of the filter cake in region 150b or other uphole regions than is desirable. However, in certain embodiments of the present disclosure, the hydrophobizing agent may delay the reaction of an acidizing breaker with the portion of filter cake 150a, for example, until the breaker fluid 122 can be circulated into the remainder of the borehole 116. This may allow for a more even removal of the filter cake 150, for example, as illustrated in FIG. 3.

The breaker fluid(s) and treatment fluid(s) of the present disclosure may directly or indirectly affect the pump 120, which representatively includes any conduits, pipelines, trucks, tubulars, and/or pipes used to fluidically convey the breaker fluid(s) and treatment fluid(s) of the present disclosure downhole, any pumps, compressors, or motors (e.g., topside or downhole) used to drive the treatment fluid(s) of the present disclosure into motion, any valves or related joints used to regulate the pressure or flow rate of the treatment fluid(s) of the present disclosure, and any sensors (i.e., pressure, temperature, flow rate, etc.), gauges, and/or combinations thereof, and the like. The breaker fluid(s) and treatment fluid(s) of the present disclosure may also directly or indirectly affect the hopper 134 and the blender unit(s) 132 and their assorted variations.

While not specifically illustrated herein, the breaker fluid(s) and treatment fluid(s) of the present disclosure may also directly or indirectly affect any transport or delivery equipment used to convey the breaker fluid(s) and treatment fluid(s) of the present disclosure to the treatment assembly 100 such as, for example, any conduits, pipelines, trucks, tubulars, and/or pipes used to fluidically move the breaker fluid(s) and treatment fluid(s) of the present disclosure from one location to another, any pumps, compressors, or motors used to drive the breaker fluid(s) and treatment fluid(s) of the present disclosure into motion, any valves or related joints used to regulate the pressure or flow rate of the breaker fluid(s) and treatment fluid(s) of the present disclosure, and any sensors (i.e., pressure and temperature), gauges, and/or combinations thereof, and the like.

To facilitate a better understanding of the present disclosure, the following examples of certain aspects of preferred embodiments are given. The following examples are not the only examples that could be given according to the present disclosure and are not intended to limit the scope of the disclosure or claims.

### EXAMPLES

### Example 1

To simulate a formation surface or particulate bridging agent being treated with a hydrophobizing agent of the present disclosure, BARACARB® 25 particulates (sized ground marble particulate bridging agent available from Halliburton Energy Services, Inc.) coated with stearic acid were prepared as follows. Stearic acid was dissolved in acetone solutions at 1% or 2% concentrations at a rate of 250 mL of acetone for each 1 g of stearic acid. The BARACARB® 25 particulates were mixed into the solutions and stirred at 600 rpm with a benchtop paddle mixer. The acetone was then allowed to evaporate, and the coated particles were placed in a drying oven at 200° F. overnight.

1-gram samples of the coated BARACARB® 25 particulates and a 1-gram sample of unmodified BARACARB® 25 particulates were each placed in a beaker with approximately 150 mL of water, and heated to 175° F. in a stirring reactor. The reactor was sealed and connected to a gas discharge apparatus. Then, 3 mL of N-FLOW™ 325 filter cake breaker (large excess as compared to the molar amount of carbonate in the BARACARB® 25) was added to each beaker. The volume of gas produced in each reactor was measured over time, the results of which are shown in Table 1 below.

TABLE 1

| | Unmodified | BARACARB ® 25 | BARACARB ® 25 |
|---|---|---|---|
| Time | BARACARB ® 25 | w/1% Stearic acid | w/2% Stearic acid |
| 35 min | 82 ml | 0 ml | 10 ml |
| 65 min | 192 ml | 28 ml | 50 ml |
| 85 min | 200 ml | 35 ml | n/a* |
| 145 min | 200 ml | 60 ml | n/a* |
| 215 min | | 105 ml | n/a* |
| 295 min | | 142 ml | n/a* |

*This sample was left in the reactor overnight, and 175 mL of gas was measured the following morning.

These data indicate that certain rock surfaces coated with a hydrophobizing agent of the present disclosure may react more slowly with an acid as compared to a similar rock surface untreated with a hydrophobizing agent of the present disclosure.

### Example 2

BARACARB® 5 and BARACARB® 25 particulates (sized ground marble particulate bridging agents available from Halliburton Energy Services, Inc.) coated with stearic acid (1% concentration) were prepared according to a procedure similar to that described in Example 1. Separately, samples of BARACARB® 5 and BARACARB® 25 particulates coated with alumina oxide (10% concentration) was prepared using a similar procedure.

Breakthrough testing was performed using each of the different types of coated BARACARB® particulates as well as samples of unmodified BARACARB® particulates. Each sample of particulates was incorporated into a drilling fluid having the formulation listed in Table 2 below. Each of the trademarked additives listed in Table 2 below is available from Halliburton Energy Services, Inc.

TABLE 2

| Component | Value |
|---|---|
| 14.2 ppg CaBr₂ brine, bbl | 0.923 |
| 11.6 ppg CaCl₂ brine, bbl | 0.077 |
| BRINEDRIL VIS ™ viscosifier, lb | 0.3 |
| N-DRIL ™ HT PLUS filtration control agent, lb | 6 |
| BARABUF ® pH buffer, lb | 3 |
| Coated or uncoated BARACARB ® 5, lb | 25 |
| Coated or uncoated BARACARB ® 25, lb | 25 |
| OXYGON ™ oxygen scavenger, lb | 1 |

Various properties of the drilling fluids were evaluated, which are reported in Table 3 below. Each of the drilling fluids was then flowed through an aloxite disk to deposit a filter cake on the disk, having the thicknesses listed in Table 3 below.

TABLE 3

| | | Stearic | Alumina |
|---|---|---|---|
| | | Acid | Oxide |
| Property | Uncoated | (1%) | (10%) |
| Apparent viscosity @ 600 rpm | 95 | 83 | 93 |
| Apparent viscosity @ 300 rpm | 54 | 51 | 46 |
| Apparent viscosity @ 200 rpm | 40 | 38 | 33 |
| Apparent viscosity @ 100 rpm | 25 | 24 | 19 |
| Apparent viscosity @ 6 rpm | 5 | 5 | 4 |
| Apparent viscosity @ 3 rpm | 3 | 4 | 3 |
| Gel strength (10 s/10 m/30 m) | 3/4/4 | 4/5/6 | 3/4/4 |
| pH | 7.265 | 7.236 | 7.203 |
| HPHT fluid loss @ 250° F., 500 psi), | 11.2 | 11.6 | 4.4 |
| mL | | | |
| Filter cake thickness | 3/32 | 3/32 | 1/32 |

An N-FLOW™ 325 filter cake breaker was applied to each filter cake (at 140° F. and 100 psi) to break the filter cakes. The filter cake comprising the unmodified BARACARB® particulates began to exhibit fluid loss after 16-24 hours, whereas the filter cakes comprising the stearic acid coated particulates and the alumina oxide coated particulates began to exhibit fluid loss after 33 hours and 60-70 hours, respectively. These data indicate that filter cakes comprising particles coated with a hydrophobizing agent of the present disclosure may react more slowly with an acid as compared to a filter cake comprising similar particles untreated with a hydrophobizing agent of the present disclosure.

An embodiment of the present disclosure is a method comprising: providing a treatment fluid comprising an aqueous base fluid and one or more hydrophobizing agents; contacting at least a portion of a surface within a subterranean formation with the treatment fluid; and allowing the hydrophobizing agent to interact with the portion of the surface within the subterranean formation to reduce its reactivity with an acid.

Another embodiment of the present disclosure is a method comprising: providing a treatment fluid comprising an aqueous base fluid and one or more hydrophobizing agents; contacting at least a portion of a filter cake in a well bore penetrating at least a portion of a subterranean formation with the treatment fluid; and allowing the hydrophobizing agent to interact with the portion of the filter cake to reduce its reactivity with an acid.

Another embodiment of the present disclosure is a method comprising: providing a particulate bridging agent treated with one or more hydrophobizing agents; introducing the particulate bridging agent into a well bore penetrating at least a portion of a subterranean formation; and forming a filter cake comprising at least a portion of the particulate bridging agent in the subterranean formation or well bore.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
providing a treatment fluid comprising an aqueous base fluid and one or more hydrophobizing agents;
contacting at least a portion of a surface within a subterranean formation with the treatment fluid; and
allowing the hydrophobizing agent to interact with the portion of the surface within the subterranean formation to reduce its reactivity with an acid.

2. The method of claim 1 wherein the hydrophobizing agent comprises at least one compound selected from the group consisting of: a polymer having one or more pendant acid moieties; a long chain fatty acid; an organosilane; silicone; silica; alumina; titania; zirconia; gold; a thiol; silver; copper; a transition metal; a nano-material; a functionalized carbon-based nano-material; a carbohydrate; a protein; a lipid; a nucleic acid; and any combination thereof.

3. The method of claim 1 wherein the hydrophobizing agent comprises stearic acid.

4. The method of claim 1 wherein the hydrophobizing agent comprises alumina.

5. The method of claim 1 wherein the surface within the subterranean formation comprises carbonate.

6. The method of claim 1 wherein the hydrophobizing agent is present in the treatment fluid in a concentration of about 1% by weight of the treatment fluid.

7. The method of claim 1 further comprising contacting the surface within the subterranean formation with a second treatment fluid comprising an acid.

8. The method of claim 7 further comprising allowing the acid to dissolve at least a portion of the surface without significantly dissolving the portion of the surface that interacted with the hydrophobizing agent.

9. A method comprising:
providing a treatment fluid comprising an aqueous base fluid and one or more hydrophobizing agents;
contacting at least a portion of a filter cake in a well bore penetrating at least a portion of a subterranean formation with the treatment fluid; and
allowing the hydrophobizing agent to interact with the portion of the filter cake to reduce its reactivity with an acid.

10. The method of claim 9 further comprising contacting at least a portion of the filter cake with a breaker fluid comprising an acid.

11. The method of claim 9 further comprising contacting at least a portion of the filter cake with a breaker fluid comprising an acid generating component.

12. The method of claim 11 further comprising introducing the breaker fluid comprising the acid generating component into the well bore using one or more pumps.

13. The method of claim 9 wherein the hydrophobizing agent comprises at least one compound selected from the group consisting of: a polymer having one or more pendant acid moieties; a long chain fatty acid; an organosilane; silicone; silica; alumina; titania; zirconia; gold; a thiol; silver; copper; a transition metal; a nano-material; a functionalized carbon-based nano-material; a carbohydrate; a protein; a lipid; a nucleic acid; and any combination thereof.

14. A method comprising:
providing a particulate bridging agent treated with one or more hydrophobizing agents;
introducing the particulate bridging agent into a well bore penetrating at least a portion of a subterranean formation; and
forming a filter cake comprising at least a portion of the particulate bridging agent in the subterranean formation or well bore.

15. The method of claim 14 wherein introducing the particulate bridging agent into the well bore comprises introducing a treatment fluid comprising a base fluid and the particulate bridging agent into the well bore.

16. The method of claim 14 wherein at least a portion of the particulate bridging agent comprises particulates coated with the one or more hydrophobizing agents.

17. The method of claim 16 wherein the particulates coated with the one or more hydrophobizing agents were treated by mixing the particulates with at least one solution of the hydrophobizing agents having a concentration of about 1% by weight.

18. The method of claim 14 further comprising contacting at least a portion of the filter cake with a breaker fluid comprising an acid.

19. The method of claim 14 further comprising contacting at least a portion of the filter cake with a breaker fluid comprising an acid generating component.

20. The method of claim 14 wherein the hydrophobizing agent comprises at least one compound selected from the group consisting of: a polymer having one or more pendant acid moieties; a long chain fatty acid; an organosilane; silicone; silica; alumina; titania; zirconia; gold; a thiol; silver; copper; a transition metal; a nano-material; a functionalized carbon-based nano-material; a carbohydrate; a protein; a lipid; a nucleic acid; and any combination thereof.
